(19) United States
(12) Patent Application Publication
(10) Pub. No.: US 2010/0088584 A1
(43) Pub. Date: Apr. 8, 2010

(54) METHODS AND SYSTEMS FOR PROCESSING A DOCUMENT IN A PRINT-PRODUCTION SYSTEM

(75) Inventors: Donald M. Pangrazio, III, LeRoy, NY (US); Anthony James Leone, III, Pittsford, NY (US)

Correspondence Address: PEPPER HAMILTON LLP, 500 GRANT STREET, ONE MELLON CENTER, 50TH FLOOR, PITTSBURGH, PA, 15219, US

(73) Assignee: XEROX CORPORATION, Norwalk, CT (US)

(21) Appl. No.: 12/245,485

(22) Filed: Oct. 3, 2008

(51) Int. Cl. G06F 17/30; G06F 17/00; G06F 7/06

(52) U.S. Cl. 715/209; 707/E17.014; 707/E17.004

(57) ABSTRACT

In an embodiment, a digital document production system may include a processor, a processor-readable storage medium in communication with the processor and an output device in communication with the processor. The processor-readable storage medium may include one or more programming instructions for identifying a file list comprising a plurality of file identifiers, selecting a first file and processing the first file using a first page box. The processor-readable storage medium may include one or more programming instructions for identifying and processing a second file based on the first page box, selecting a third file, processing the third file using a second page box and identifying and processing a fourth file based on the second page box. In addition, the processor-readable storage medium may include one or more programming instructions for printing the corresponding processed file for each file identifier in the file list.

### BACKGROUND

It is common for books, documents and/or the like to be created, mastered and stored as multiple single-page portable document format (“PDF”) files. Formatting a book as multiple single-page PDF files rather than as a single multi-page PDF file allows for multiple author revisions and quick and isolated updates.

Printing the entire book as a collated compilation usually requires performing a centering operation on each individual file and then printing the individual files as a single print job. A problem arises when the file images are not centered within corresponding page boxes. To address this problem, a pre-press operator is often required to add a page box, such as a trim box, to each file so that the image is centered within the page box. However, this is a tedious and time consuming process that adds significant processing time to the document production process.

### SUMMARY

Before the present methods are described, it is to be understood that this invention is not limited to the particular systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a digital document production system may include a processor, a processor-readable storage medium in communication with the processor and an output device in communication with the processor. The processor-readable storage medium may include one or more programming instructions for identifying a file list comprising a plurality of file identifiers. Each file identifier may correspond to a file, a position of each file identifier in the file list may correspond to a page number in a document, each file may correspond to a single-page in the document and each file may correspond to a digital representation of an image. The processor-readable storage medium may include one or more programming instructions for selecting a first file associated with a first file identifier having a position corresponding to a first page number in the document, where the first page number is an odd number, processing the first file by substantially centering the corresponding digital representation of the image within the first file using a first page box, identifying a second file corresponding to a second file identifier having a position corresponding to an odd page number in the document and processing the second file by positioning the corresponding digital representation of the image within the second file based on a position of the first page box. The processor-readable storage medium may also include one or more programming instructions for selecting a third file associated with a third file identifier having a position corresponding to a second page number in the document, where the second page number is an even number, processing the third file by substantially centering the corresponding digital representation of the image within the third file using a second page box, identifying a fourth file corresponding to a fourth file identifier having a position corresponding to an even page number in the document and processing the fourth file by positioning the corresponding digital representation of the image within the fourth file based on a position of the second page box. In addition, the processor-readable storage medium may include one or more programming instructions for printing the corresponding processed file for each file identifier in the file list.

In an embodiment, a method of processing a document may include identifying a file list comprising a plurality of file identifiers. Each file identifier may correspond to a file, a position of each file identifier in the file list may correspond to a page number in a document, each file may correspond to a single-page in the document, and each file may correspond to a digital representation of an image. The method may also include selecting a first file associated with a first file identifier having a position corresponding to a first page number in the document, where the first page number has a first characteristic and processing the first file by substantially centering the corresponding digital representation of the image within the first file using a first page box. The method may also include identifying a second file corresponding to a second file identifier having a position corresponding to a page number having the first characteristic and processing the second file by positioning the corresponding digital representation of the image within the second file based on a position of the first page box. In addition, the method may include selecting a third file associated with a third file identifier having a position corresponding to a second page number in the document, where the second page number has a second characteristic, processing the third file by substantially centering the corresponding digital representation of the image within the third file using a second page box, identifying a fourth file corresponding to a fourth file identifier having a position corresponding to a page number having the second characteristic and processing the fourth file by positioning the corresponding digital representation of the image within the fourth file based on a position of the second page box. The method may also include printing, by a printing device, the corresponding processed file for each file identifier in the file list.

In an embodiment, a device for processing a document may include a processor, a processor-readable storage medium in communication with the processor and a printing subsystem in communication with the processor. The processor-readable storage medium may include one or more programming instructions for identifying a file list comprising a plurality of file identifiers. Each file identifier may correspond to a file, a position of each file identifier in the file list may correspond to a page number in a document, each file may correspond to a single-page in the document, and each file may correspond to a digital representation of an image. The processor-readable storage medium may also include one or more programming instructions for selecting a first file associated with a first file identifier having a position corresponding to a first page number in the document, where the first page number has a first characteristic, processing the first file by substantially centering the corresponding digital representation of the image within the first file using a first page box, identifying a second file corresponding to a second file identifier having a position corresponding to a page number having the first characteristic and processing the second file by positioning the corresponding digital representation of the image within the second file based on a position of the first page box. The processor-readable storage medium may include one or more programming instructions for selecting a third file associated with a third file identifier having a position corresponding to a second page number in the document, where the second page number has a second characteristic, processing the third file by substantially centering the corresponding digital representation of the image within the third file using a second page box, identifying a fourth file corresponding to a fourth file identifier having a position corresponding to a page number having the second characteristic and processing the fourth file by positioning the corresponding digital representation of the image within the fourth file based on a position of the second page box. In addition, the processor-readable storage medium may include one or more programming instructions for printing the corresponding processed file for each file identifier in the file list.

### BRIEF DESCRIPTION OF THE DRAWINGS

Aspects, features, benefits and advantages of the present invention will be apparent with regard to the following description and accompanying drawings, of which:

FIG. 1 illustrates an exemplary method of processing a document according to an embodiment.

FIG. 2 illustrates an exemplary file list according to an embodiment.

FIG. 3 illustrates exemplary page boxes according to an embodiment.

FIG. 4 illustrates an exemplary graphical user interface that may be used to define a page box according to an embodiment.

FIG. 5 illustrates a block diagram of exemplary internal hardware that may be used to contain or implement the program instructions according to an embodiment.

FIG. 6 illustrates an exemplary device according to an embodiment.

### DETAILED DESCRIPTION

For purposes of the discussion below, a “document” refers to a multi-page publication. Exemplary documents may include books, workbooks and/or the like.

A “file” refers to a page description language (“PDL”) document, such as a portable file format (“PDF”) file, a post script (“PS”) document and/or any other similar file having uniform page positioning. A file may include a single page of a document.

A “page box” refers to a modifiable, rectangular region that may encompass a portion of a file. Exemplary page boxes may include a crop box, a bleed box, a media box, a trim box and/or the like.

A “crop box” defines a region to which a file's contents are to be cropped.

A “bleed box” defines a region to which a file's contents are to be trimmed when output by a production environment.

A “media box” defines the width and height of a page.

A “trim box” defines the intended dimensions of a finished page.

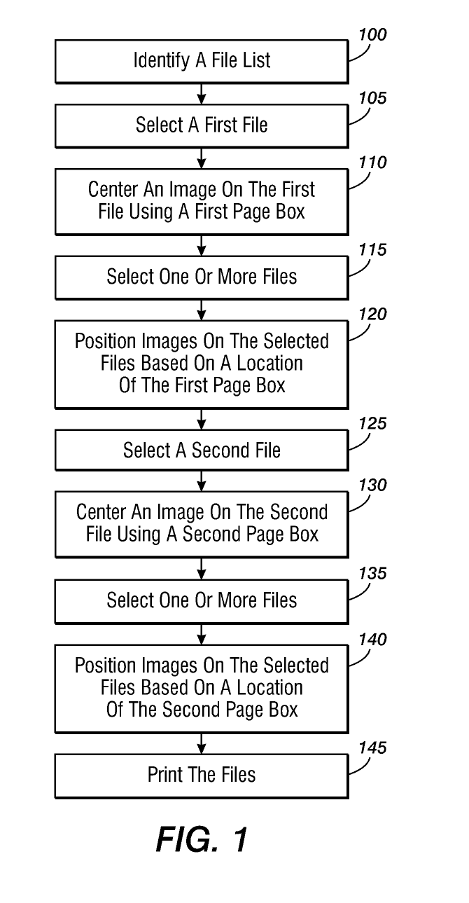

FIG. 1 illustrates an exemplary method of processing a document according to an embodiment. In an embodiment, a file list may be identified 100. A file list may include information regarding a plurality of files corresponding to a document.

In an embodiment, each file may represent a single page of a document, and each page may include a digital representation of an image. In an embodiment, an image may include text, one or more pictures, one or more drawings and/or the like. In an embodiment, an image may refer to content on a page. For example, a page may include three paragraphs of text and two photographs. The image associated with that page may include the three paragraphs of text and the two photographs.

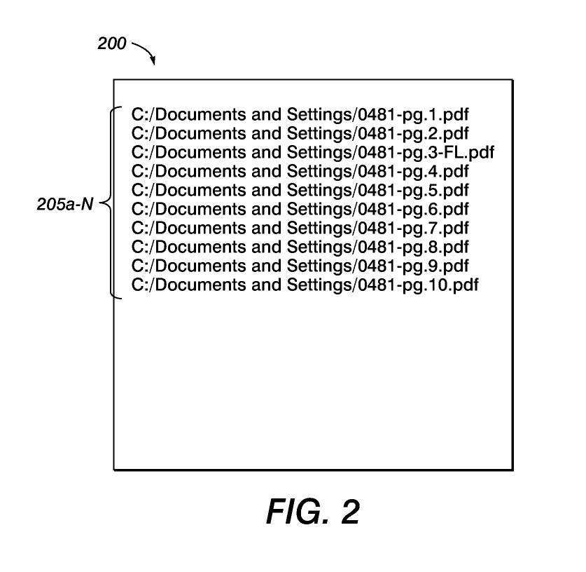

In an embodiment, a file list may include one or more file identifiers that may correspond to a name, a location, an order and/or the like associated with each file. FIG. 2 illustrates an exemplary file list according to an embodiment. As illustrated by FIG. 2, the file list 200 includes file identifiers for ten files 205a-N. For example, the file list 200 includes a file identifier (i.e., “C:/Documents and Settings/0481-pg.1.pdf”) corresponding to the name and path location of a first file.

In an embodiment, the order of the file identifiers in the file list may represent the order of the files in the document. As such, each file identifier in the file list may correspond to a document page number based on its location in the file list. For example, referring to FIG. 2, the file identifier at the top of the file list, “C:/Documents and Settings/0481-pg.1.pdf,” may correspond to the first file in the document, while the file identifier at the bottom of the file list, “C:/Documents and Settings/0481-pg.10.pdf,” may correspond to the last file in the document. As such, the first file may correspond to page 1 of the document, while the last file may correspond to page 10 of the document.

In an embodiment, a first file may be selected 105. In an embodiment, the first file may be selected 105 based on the position of its corresponding file identifier in the file list. For example, the file corresponding to the first file identifier in the file list may be selected first, the file corresponding to the second file identifier in the file list may be selected second, and so on.

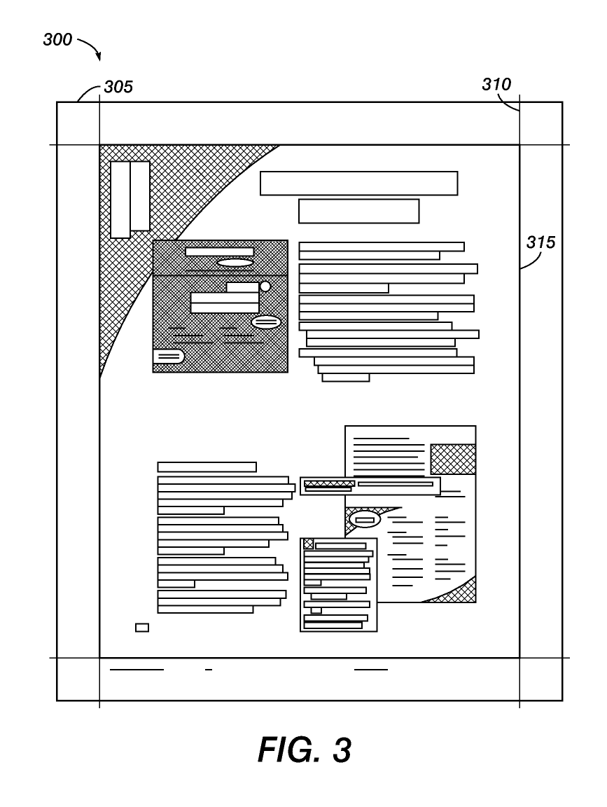

In an embodiment, the image corresponding to the first file may be substantially centered 110 within the first file. In an embodiment, the modified first file may correspond to the same file identifier as the original first file. The image may be centered 110 based on a page box associated with the first file. A page box may be a modifiable, rectangular region that may encompass a portion of a file. Exemplary page boxes may include a crop box, a bleed box, a media box, a trim box and/or the like. FIG. 3 illustrates exemplary page boxes according to an embodiment. As illustrated by FIG. 3, a page 300 may include a media box 305, a bleed box 310 and a trim box 315.

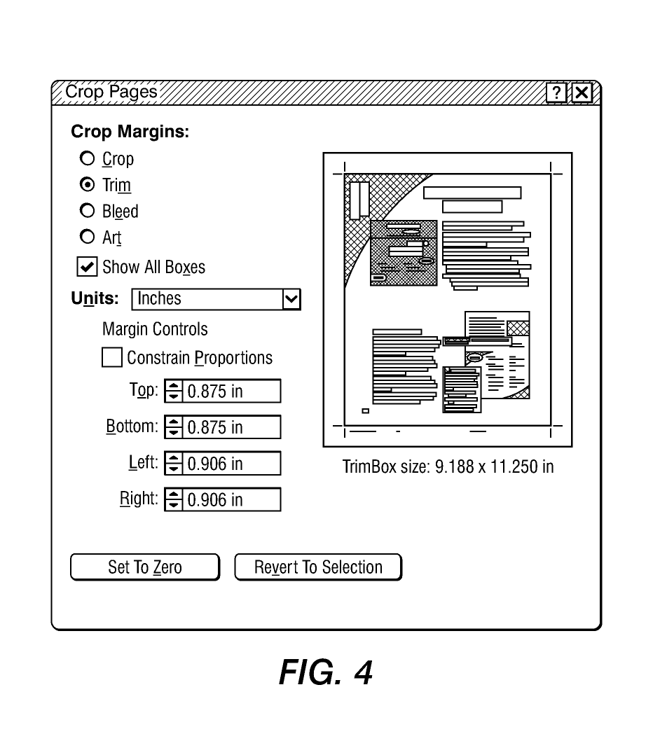

In an embodiment, a page box associated with a first file may be set so that the image associated with the first file is substantially centered within the page box. FIG. 4 illustrates an exemplary graphical user interface that may be used to define a page box. As illustrated by FIG. 4, a user may set one or more margins associated with the page box. In an embodiment, a page box may be set automatically.

In an embodiment, one or more files may be selected 115. Each file may be selected 115 based on a location of its corresponding file identifier in the file list. In an embodiment, one or more files that are associated with document page numbers that share a characteristic with the document page number of the first file may be selected 115. For example, if the first file is associated with an odd document page number, one or more files associated with odd document page numbers may be selected 115.

In an embodiment, the image associated with each file that is selected may be positioned 120 within the file. In an embodiment, each image may be automatically positioned 120 based on a position of the page box associated with the first file. For example, a first file may correspond to page number ‘1’, and the image of the first file may be centered 110 in a trim box to produce a first centered image. One or more files associated with odd page numbers may be selected 115, and the images associated with each selected file may be positioned 120 based on a location of, for example, the trim box associated with the first file. In an embodiment, each modified file may correspond to the same file identifier as the original file.

In an embodiment, a second file may be selected 125. A second file may correspond to a document page number having a different characteristic than the document page number of the first file. For example, if the first file corresponds to an odd page number, the second file may correspond to an even page number.

In an embodiment, the image corresponding to the second file may be substantially centered 130 within the second file. The image may be centered 130 based on a page box associated with the second file. In an embodiment, a page box associated with the second file may be set so that the image associated with the second file is substantially centered within the page box. In an embodiment, the modified second file may correspond to the same file identifier as the original second file.

In an embodiment, one or more files may be selected 135. Each file may be selected 135 based on a location of its corresponding file identifier in the file list. In an embodiment, one or more files that are associated with document page numbers that share a characteristic with the document page number of the second file may be selected 135. For example, if the second file is associated with an even document page number, one or more files associated with even document page numbers may be selected 115.

In an embodiment, the image associated with each file that is selected based on the document page number associated with the second file may be positioned 140 with the file. In an embodiment, each image may be automatically positioned 140 based on the page box associated with the second file. For example, a second file may correspond to page number ‘2’, and the image of the second file may be centered 130 in a trim box to produce a second centered image. One or more files corresponding to even page numbers may be selected 135, and the images associated with each selected file may be positioned 140 based on a location of, for example, the trim box associated with second file. In an embodiment, each modified file may correspond to the same file identifier as the original file.

In an embodiment, the modified files may be printed 145. For example, the modified file associated with each file identifier in the file list may be printed 145 as a collated set.

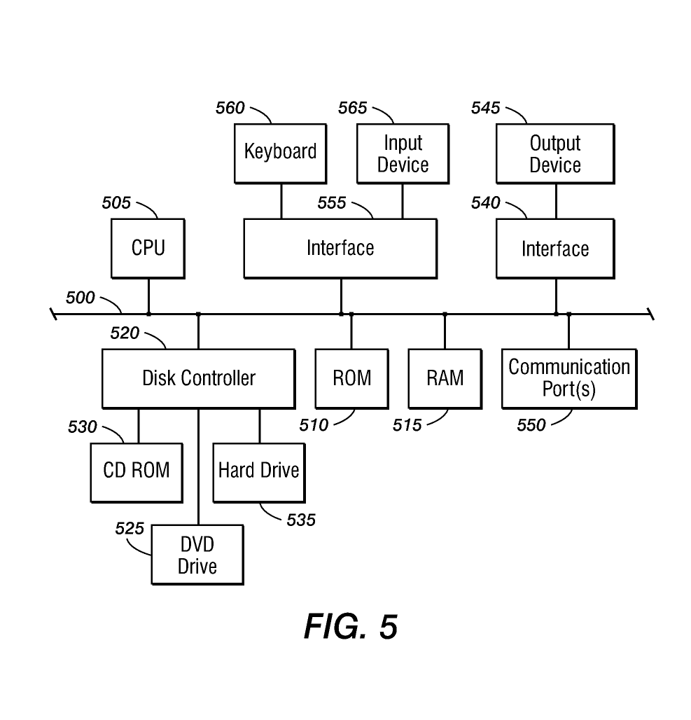

FIG. 5 depicts a block diagram of exemplary internal hardware that may be used to contain or implement the program instructions according to an embodiment. A bus 500 serves as the main information highway interconnecting the other illustrated components of the hardware. CPU 505 is the central processing unit of the system, performing calculations and logic operations required to execute a program. Read only memory (ROM) 510 and random access memory (RAM) 515 constitute exemplary memory devices.

A disk controller 520 interfaces with one or more optional disk drives to the system bus 500. These disk drives may include, for example, external or internal DVD drives 525, CD ROM drives 530 or hard drives 535. As indicated previously, these various disk drives and disk controllers are optional devices.

Program instructions may be stored in the ROM 510 and/or the RAM 515. Optionally, program instructions may be stored on a tangible computer readable medium such as a compact disk, a digital disk or other tangible recording medium.

An optional interface 540 may permit information from the bus 500 to be transmitted to an output device 545. For example, the interface 540 may permit information from the bus 500 to be displayed on a display in audio, graphic or alphanumeric format. In an embodiment, the interface 540 may permit information from the bus 500 to be printed by a printing device. Additional and/or alternate output devices may be used within the scope of this disclosure. Communication with external devices may occur using various communication ports 550. An exemplary communication port 550 may be attached to a communications network, such as the Internet or an intranet.

In an embodiment, the hardware may include an interface 555 which allows for receipt of data from input devices such as a keyboard 560 or other input device 565 such as a mouse, a touch screen, a remote control, a pointer and/or a joystick.

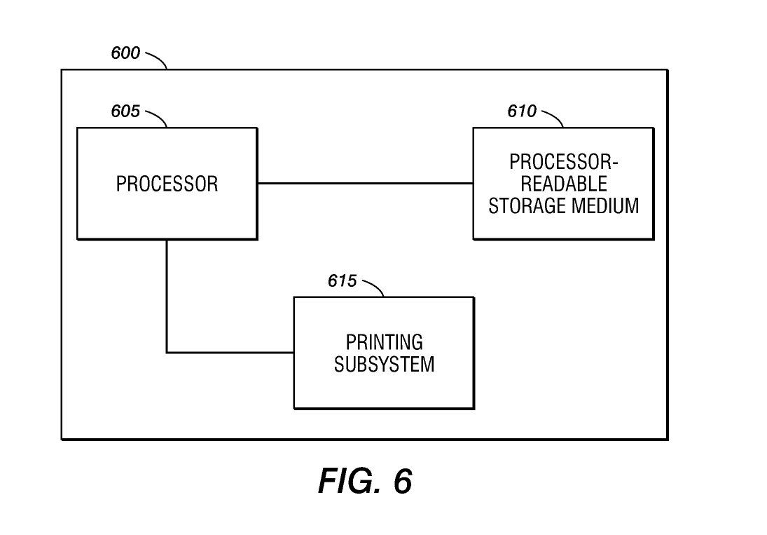

An embedded system, such as a sub-system within a xerographic apparatus, may optionally be used to perform one, some or all of the operations described herein. FIG. 6 illustrates an exemplary device that may perform one, some or all of the operations described herein. As illustrated by FIG. 6, the device 600 may include a processor 605, a processor-readable storage medium 610 in communication with the processor, and a printing subsystem 615 in communication with the processor. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A digital document production system comprising:
a processor;
a processor-readable storage medium in communication with the processor; and
an output device in communication with the processor,
wherein the processor-readable storage medium comprises one or more programming instructions for:
identifying a file list comprising a plurality of file identifiers, wherein each file identifier corresponds to a file, wherein a position of each file identifier in the file list corresponds to a page number in a document, wherein each file corresponds to a single-page in the document, wherein each file corresponds to a digital representation of an image,
selecting a first file associated with a first file identifier having a position corresponding to a first page number in the document, wherein the first page number is an odd number,
processing the first file by substantially centering the corresponding digital representation of the image within the first file using a first page box,
identifying a second file corresponding to a second file identifier having a position corresponding to an odd page number in the document,
processing the second file by positioning the corresponding digital representation of the image within the second file based on a position of the first page box,
selecting a third file associated with a third file identifier having a position corresponding to a second page number in the document, wherein the second page number is an even number,
processing the third file by substantially centering the corresponding digital representation of the image within the third file using a second page box,
identifying a fourth file corresponding to a fourth file identifier having a position corresponding to an even page number in the document,
processing the fourth file by positioning the corresponding digital representation of the image within the fourth file based on a position of the second page box, and
for each file identifier in the file list, printing the corresponding processed file.

2. The system of claim 1, wherein the one or more programming instructions for processing the first file comprises one or more programming instructions for:
selecting the first page box from one or more of the following:
a crop box,
a bleed box,
a media box, and
a trim box; and
setting the first page box within the first file such that the corresponding digital representation of the image is substantially centered within the first page box.

3. The system of claim 2, wherein the one or more programming instructions for setting the first page box comprises one or more programming instructions for:
receiving information associated with a position of the first page box from a user; and
substantially centering the digital representation of the image corresponding to the first file within the first page box based on the received information.

4. The system of claim 1, wherein the one or more programming instructions for processing the second file comprises one or more programming instructions for:
selecting the second page box from one or more of the following:
a crop box,
a bleed box,
a media box, and
a trim box; and
setting the second page box within the second file such that the corresponding digital representation of the image is substantially centered within the second page box.

5. The method of claim 4, wherein the one or more programming instructions for setting the second page box comprises one or more programming instructions for:
receiving information associated with a position of the second page box from a user; and
substantially centering the digital representation of the image corresponding to the second file within the second page box based on the received information.

6. A method of processing a document, the method comprising:
identifying a file list comprising a plurality of file identifiers, wherein each file identifier corresponds to a file, wherein a position of each file identifier in the file list corresponds to a page number in a document, wherein each file corresponds to a single-page in the document, wherein each file corresponds to a digital representation of an image;
selecting a first file associated with a first file identifier having a position corresponding to a first page number in the document, wherein the first page number has a first characteristic;
processing the first file by substantially centering the corresponding digital representation of the image within the first file using a first page box;
identifying a second file corresponding to a second file identifier having a position corresponding to a page number having the first characteristic;
processing the second file by positioning the corresponding digital representation of the image within the second file based on a position of the first page box;
selecting a third file associated with a third file identifier having a position corresponding to a second page number in the document, wherein the second page number has a second characteristic;
processing the third file by substantially centering the corresponding digital representation of the image within the third file using a second page box;
identifying a fourth file corresponding to a fourth file identifier having a position corresponding to a page number having the second characteristic;
processing the fourth file by positioning the corresponding digital representation of the image within the fourth file based on a position of the second page box; and
for each file identifier in the file list, printing, by a printing device, the corresponding processed file.

7. The method of claim 6, further comprising:
repeating the identifying a second file and the processing the second file for each file corresponding to a file identifier having a position corresponding to a page number having the first characteristic.

8. The method of claim 6, further comprising:
repeating the identifying a fourth file and the processing the fourth file for each file corresponding to a file identifier having a position corresponding to a page number having the second characteristic.

9. The method of claim 6, wherein each file comprises a portable document format file.

10. The method of claim 6, wherein substantially centering the corresponding digital representation of the image within the first file comprises:
selecting the first page box from one or more of the following:
a crop box,
a bleed box,
a media box, and
a trim box; and
setting the first page box within the corresponding document such that the corresponding digital representation of the image is substantially centered within the first page box.

11. The method of claim 10, wherein setting the first page box comprises:
receiving information associated with a position of the first page box from a user; and
substantially centering the digital representation of the image corresponding to the first file within the first page box based on the received information.

12. The method of claim 6, wherein substantially centering the corresponding digital representation of the image within the second file comprises:
selecting the second page box from one or more of the following:
a crop box,
a bleed box,
a media box, and
a trim box; and
setting the second page box within the second file such that the corresponding digital representation of the image is substantially centered within the second page box.

13. The method of claim 12, wherein setting the second page box comprises:
receiving information associated with a position of the second page box from a user; and
substantially centering the digital representation of the image corresponding to the second file within the second page box based on the received information.

14. The method of claim 6, wherein:
the first characteristic is that the page number is odd, and
the second characteristic is that the page number is even.

15. A device for processing a document, the device comprising:
a processor;
a processor-readable storage medium in communication with the processor; and
a printing subsystem in communication with the processor,
wherein the processor-readable storage medium comprises one or more programming instructions for:
identifying a file list comprising a plurality of file identifiers, wherein each file identifier corresponds to a file, wherein a position of each file identifier in the file list corresponds to a page number in a document, wherein each file corresponds to a single-page in the document, wherein each file corresponds to a digital representation of an image,
selecting a first file associated with a first file identifier having a position corresponding to a first page number in the document, wherein the first page number has a first characteristic,
processing the first file by substantially centering the corresponding digital representation of the image within the first file using a first page box,
identifying a second file corresponding to a second file identifier having a position corresponding to a page number having the first characteristic;
processing the second file by positioning the corresponding digital representation of the image within the second file based on a position of the first page box;
selecting a third file associated with a third file identifier having a position corresponding to a second page number in the document, wherein the second page number has a second characteristic,
processing the third file by substantially centering the corresponding digital representation of the image within the third file using a second page box;
identifying a fourth file corresponding to a fourth file identifier having a position corresponding to a page number having the second characteristic;
processing the fourth file by positioning the corresponding digital representation of the image within the fourth file based on a position of the second page box; and
for each file identifier in the file list, printing the corresponding processed file.

16. The device of claim 15, wherein the one or more programming instructions for substantially centering the corresponding digital representation of the image within the first file comprises one or more programming instructions for:
selecting the first page box from one or more of the following:
a crop box,
a bleed box,
a media box, and
a trim box; and
setting the first page box within the corresponding document such that the corresponding digital representation of the image is substantially centered within the first page box.

17. The device of claim 16, wherein the one or more programming instructions for setting the first page box comprises one or more programming instructions for:
receiving information associated with a position of the first page box from a user; and
substantially centering the digital representation of the image corresponding to the first file within the first page box based on the received information.

18. The device of claim 15, wherein the one or more programming instructions for substantially centering the corresponding digital representation of the image within the second file comprises one or more programming instructions for:
selecting the second page box from one or more of the following:
a crop box,
a bleed box,
a media box, and
a trim box; and
setting the second page box within the second file such that the corresponding digital representation of the image is substantially centered within the second page box.

19. The device of claim 18, wherein the one or more programming instructions for setting the second page box comprises one or more programming instructions for:
receiving information associated with a position of the second page box from a user; and
substantially centering the digital representation of the image corresponding to the second file within the second page box based on the received information.
